(19) United States
(12) Patent Application Publication
(10) Pub. No.: US 2016/0281767 A1
(43) Pub. Date: Sep. 29, 2016

(54) VEHICLE PROPELLER SHAFT

(71) Applicant: Showa Corporation, Gyoda-shi (JP)

(72) Inventor: Kenichi MORI, Haga-gun (JP)

(73) Assignee: Showa Corporation, Gyoda-shi (JP)

(21) Appl. No.: 14/982,640

(22) Filed: Dec. 29, 2015

(30) Foreign Application Priority Data
Mar. 26, 2015 (JP) 2015-064406

(51) Int. Cl. F16D 3/00

(52) U.S. Cl. CPC F16C 3/023; F16C 3/026; F16D 3/16; F16D 3/84; F16F 15/322; F16F 15/34; F16D 2300/22

(57) ABSTRACT

To provide a vehicle propeller shaft capable of improving the efficiency in the balance correction operation as well as reducing the size and weight of a universal joint. A vehicle propeller shaft according to the present invention includes tubular bodies extending in a front and rear direction, balance weights arranged on outer peripheral surfaces of the tubular bodies and covering members covering the outer peripheral surfaces of the tubular bodies and the balance weights, in which the covering members are formed of a heat shrinkable tube which shrinks by heating.

### CROSS-REFERENCE TO RELATED APPLICATIONS

This application claims the benefit of Japanese Patent Application JP 2015-064406, filed Mar. 26, 2015, the entire content of which is hereby incorporated by reference, the same as if set forth at length.

### BACKGROUND OF THE INVENTION

1. Field of the Invention

The present invention relates to a vehicle propeller shaft.

2. Description of Related Art

In a FF-based four-wheel drive vehicle, a motor and a transmission are mounted in a front section and a final drive gear is mounted on a rear section. A vehicle propeller shaft (hereinafter may be referred to as merely a “propeller shaft”) which extends in a front and rear direction of the vehicle has been hitherto used as a member for connecting the transmission arranged in the front section to the final drive gear arranged in the rear section.

As a distance between the transmission and the final drive gear is not fixed and as rotation centers of an output shaft of the transmission and an input shaft of the final drive gear are not on the same axis, a universal joint is provided between the propeller shaft and the transmission and so on.

The propeller shaft has been formed of a cylindrical tubular body which is made of metal in related art, however, the propeller shaft may be formed of a tubular body made of carbon-fiber-reinforced plastic (hereinafter also referred to as “CFRP”) in recent years.

In the case where the propeller shaft is formed of the tubular body made of CFRP, a fitting portion of the universal joint is fitted into an opening of the tubular body to thereby connect the propeller shaft (tubular body) to the universal joint.

When using the above propeller shaft, in the case where a compression load in the front and rear direction (axial direction) is acted on the propeller shaft by the collision of the vehicle, the universal joint splits the propeller shaft (tubular body) in the axial direction to shorten the propeller shaft. As a result, the motor and the transmission easily retract from an engine room, and collision energy can be absorbed by a body panel of the engine room.

Also in the propeller shaft, in the case of where the center of gravity does not match the rotation center, namely, in the case of imbalance, vibration occurs at the time of rotation. Such vibration is undesirable as it gives a passenger an unpleasant feeling when transmitted inside the vehicle. Accordingly, a balance correction operation in which a balance weight is fixed to keep a balance after assembling the propeller shaft is performed (refer to JP-A-3-265738 (Patent Document 1), JP-A-2009-227028 (Patent Document 2))

Concerning the balance correction, a molten resin containing a magnetic material is poured into the tubular body made of CFRP in Patent Document 1. Then, the cured resin is used as a balance weight.

In Patent Document 2, a columnar portion to be welded (refer to a “neck portion 22”) is provided between a yoke portion and a fitting portion of the universal joint. Then, the balance weight is fixed to an outer peripheral surface of the portion to be welded.

### SUMMARY OF THE INVENTION

However, it is difficult to induce the molten resin by a magnetic force to a predetermined portion in the balance corrosion according to Patent Document 1. Furthermore, it takes a relatively long time to wait for curing of the resin. Accordingly, work efficiency is low.

When welding is used as in the balance correction of Patent Document 2, it is difficult to apply coating (rust prevention treatment) to the portion to be welded and the balance weight before welding. Accordingly, it is necessary to apply coating after the balance weight is fixed by welding, and work efficiency is low.

Thus, the development of the propeller shaft capable of improving efficiency in the balance correction operation is desired.

Furthermore, in the case where the propeller shaft is formed of the tubular body made of CFRP, the portion to be welded is necessary in the universal joint as disclosed in Patent Document 2, which incurs the increase in size and weight of the universal joint. Accordingly, the development of the propeller shaft capable of reducing the size and weight of the universal joint is desired.

The present invention has been made in view of the above problems, and an object thereof is to provide a vehicle propeller shaft capable of improving the efficiency in the balance correction operation as well as reducing the size and weight of the universal joint.

According to an embodiment of the present invention, there is provided a vehicle propeller shaft including tubular bodies extending in a front and rear direction, balance weights arranged on outer peripheral surfaces of the tubular bodies, and covering members covering the outer peripheral surfaces of the tubular bodies and the balance weights, in which the covering members are formed of a heat shrinkable tube which shrinks by heating.

According the present invention, as the covering members for fixing the balance weights can be formed by heating the heat shrinkable tube, the work of fixing the balance weights can be performed easily. Additionally, it is not necessary to induce the resin by a magnetic force or to wait for curing of the resin as explained in the related art. Moreover, it is not necessary to apply coating (rust prevention treatment) of the balance weights and so on after fixing the balance weights as the balance weights are not exposed because the balance weights are covered with the covering members.

As described above, the efficiency in the balance correction operation can be improved by the present invention.

Also according to the present invention, as the balance weights are fixed to the tubular bodies, it is not necessary to provide portions to be welded in the universal joint. Therefore, the universal joints can be reduced in size and weight.

It is preferable that the covering members cover matching surfaces of universal joints connected to end portions of the tubular bodies and the end portions of the tubular bodies.

According to the above structure, the intrusion of water into the tubular bodies hardly occurs as the matching surfaces are covered with the covering members. Accordingly, portions inserted into the tubular bodies to be fitted (fitting portions) in the universal joint hardly rust.

It is preferable that the balance weights are adhered to the tubular bodies by an adhesive.

According to the above structure, the fixing force of the balance weights is improved. The displacement of the balance weights can be prevented when the heat shrinkable tube is shrunk by heating.

The tubular bodies may be made of any one of carbon-fiber-reinforced plastic, steel and aluminum.

According to the present invention, the vehicle propeller shaft capable of improving the efficiency in the balance correction operation as well as reducing the size and weight of the universal joint can be provided.

### BRIEF DESCRIPTION OF THE DRAWINGS

FIG. 1 is a plan view of a propeller shaft viewed in a plane according of an embodiment;

FIG. 2 is an enlarged view of a range surrounded by a frame line II of FIG. 1;

FIG. 3 is a cross-sectional view of a range surrounded by a frame line III of FIG. 2;

FIG. 4 is an end view along an arrow IV-IV of FIG. 2;

FIGS. 5A to 5D are views for explaining processes of forming a covering member, in which FIG. 5A is a view showing a state before a balance weight is arranged, FIG. 5B is a view showing a state where the balance weight is arranged, FIG. 5C is a view showing a state where a heat shrinkable tube is arranged and FIG. 5D is a view showing a state after the heat shrinkable tube is heated.

### DETAILED DESCRIPTION OF THE INVENTION

An embodiment of the present invention will be explained appropriately with reference to the drawings.

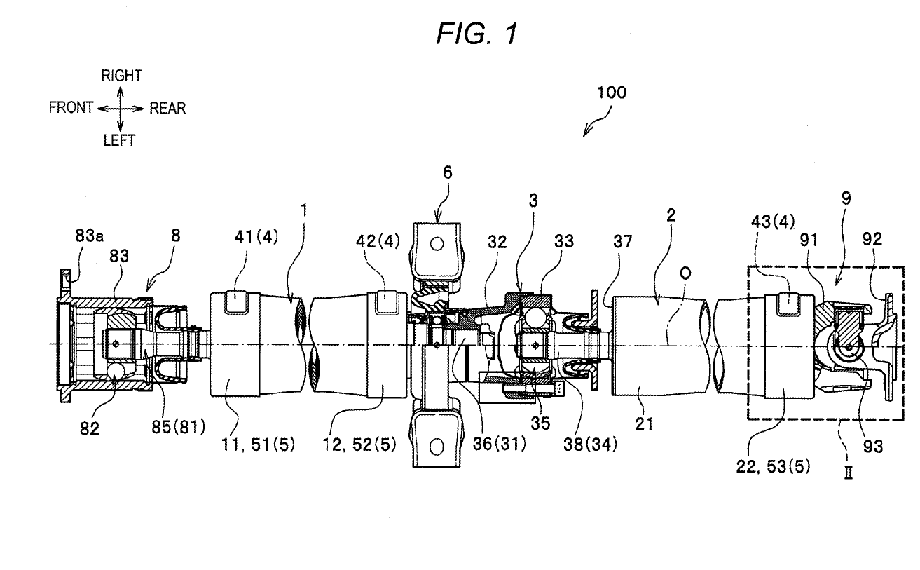

As shown in FIG. 1, a propeller shaft 100 is a power transmission shaft mounted on a FF-based four-wheel drive vehicle and extending in a front and rear direction.

A first constant velocity joint 8 is connected to a front side of the propeller shaft 100. The power outputted from a transmission (not shown) in the front section of the vehicle is transmitted to the propeller shaft 100 through the first constant velocity joint 8, and the propeller shaft 100 rotates around a central shaft O.

A cardan joint 9 is connected to a rear side of the propeller shaft 100. The power inputted to the propeller shaft 100 is transmitted to the final drive gear (not shown) through the cardan joint 9 to thereby drive rear wheels.

The propeller shaft 100 has a two-piece structure which is divided at an intermediate section.

The propeller shaft 100 includes a first propeller shaft (tubular body) 1 arranged close to the front of the vehicle, a second propeller shaft (tubular body) 2 arranged at a rear part of the first propeller shaft 1, a second constant velocity joint 3 connecting a rear end portion 12 of the first propeller shaft 1 to a front end portion 21 of the second propeller shaft 2, three balance weights 4 and three covering members 5 covering outer peripheral surfaces of the first propeller shaft 1 and the second propeller shaft 2 and the balance weights 4.

### First Propeller Shaft

The first propeller shaft 1 is made of CFRP, which is a cylindrical tubular body extending in a front and rear direction.

In a front end portion 11 of the first propeller shaft 1, an opening into which a fitting portion (not shown) of a later-described first stub shaft 81 of the first constant velocity joint 8 is inserted is formed.

In the rear end portion 12 of the first propeller shaft 1, a fitting portion (not shown) of a later-described second stub shaft 31 of the second constant velocity joint 3 is inserted is formed.

### Second Propeller Shaft

The second propeller shaft 2 is made of CFRP, which is a cylindrical tubular body extending in the front and rear direction.

In the front end portion 21 of the second propeller shaft 2, an opening into which a fitting portion (not shown) of a later-described third stub shaft 34 of the second constant velocity joint 3 is inserted is formed.

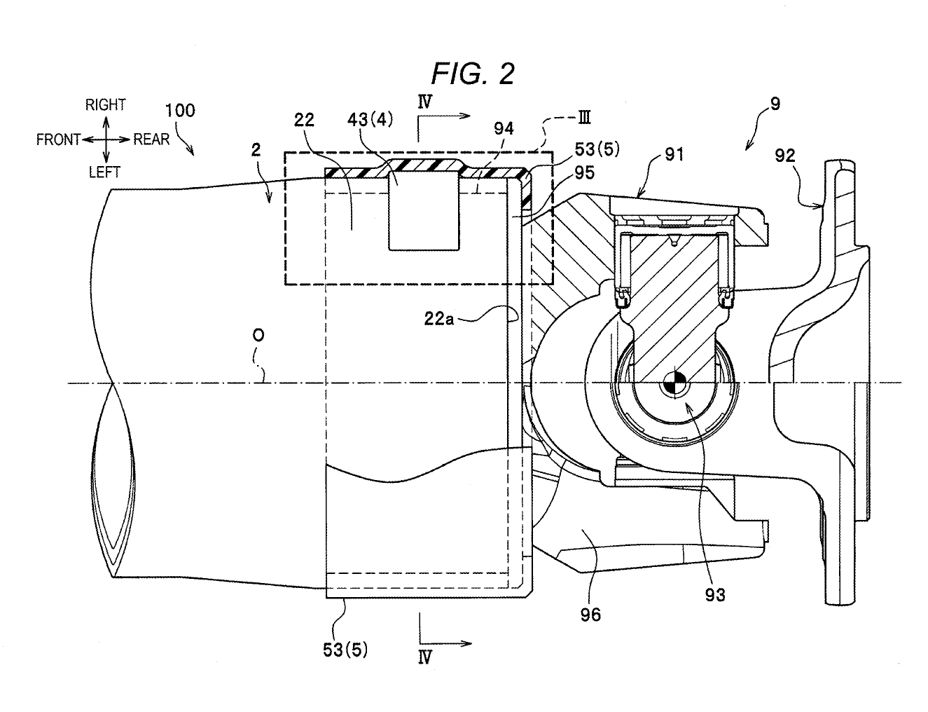

As shown in FIG. 2, in a rear end portion 22 of the second propeller shaft 2, an opening 22a into which a fitting portion 94 of a later-described stub yoke 91 of the cardan joint 9 is inserted is formed.

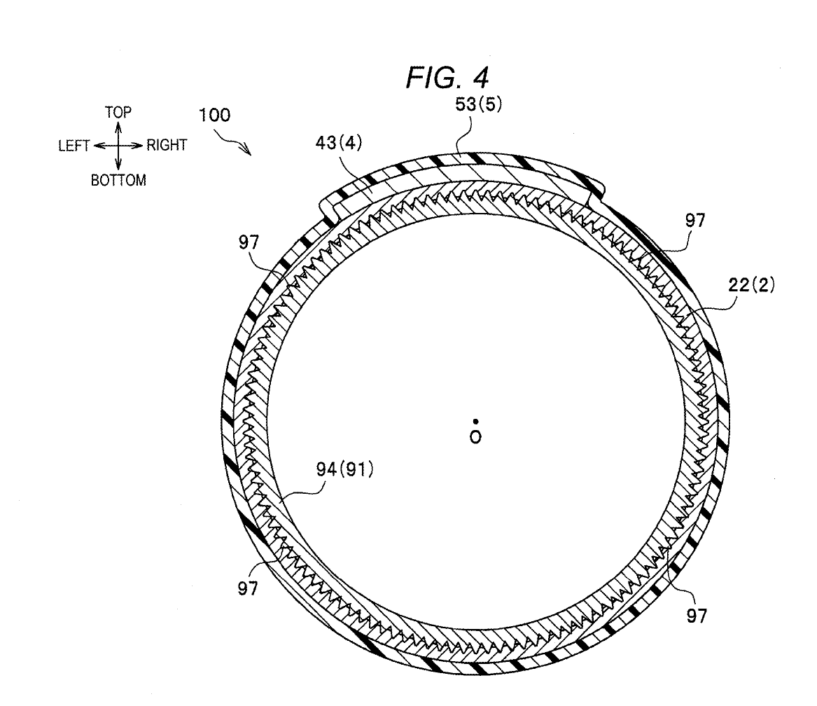

As shown in FIG. 4, the fitting portion 94 of the stub yoke 91 is fitted into the rear end portion 22 of the second propeller portion 2.

Concerning the fitting, plural sharp outer peripheral ridges 97 projecting outward in a radial direction and extending in the front and rear direction are formed in a circumferential direction of the fitting portion 94. On the other hand, an inner peripheral surface of the rear end portion 22 is formed in a circular shape having a smaller diameter than the outer peripheral ridges 97 before the fitting portion 94 is fitted. When the fitting portion 94 is inserted into the rear end portion 22, the outer ridges 97 are fitted to the inner peripheral surface of the rear end portion 22 so as to bite into the inner peripheral surface.

The outer peripheral ridges 97 are also formed in the fitting portion of the first stub shaft, the fitting portion of the second stub shaft and the fitting portion of the third stub shaft, though not particularly shown.

Next, the universal joint (the cardan joint 9, the first constant velocity joint 8 and the second constant velocity joint 3) will be explained.

### Cardan Joint

As shown in FIG. 2, the cardan joint 9 includes a stub yoke 91 connecting to the rear end portion 22 of the second propeller shaft 2, a flange yoke 92 fastened to a companion flange connecting to an input shaft of the final drive gear and a trunnion 93 connecting the stub yoke 91 to the flange yoke 92.

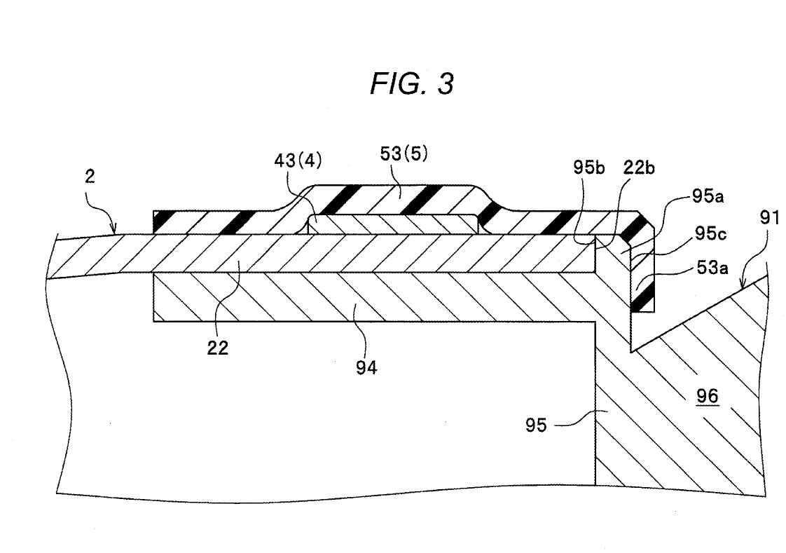

As shown in FIG. 2 and FIG. 3, the stub yoke 91 includes the fitting portion 94 fitted into the rear end portion 22 of the second propeller shaft 2, a disc-shaped lid portion 95 blocking the opening 22a of the rear end portion 22 of the second propeller shaft 2 and a yoke portion 96 forking into two from the lid portion 95 to the rear side to rotatably support the trunnion 93. These components are integrally formed.

That is, the stub yoke 91 in which a columnar portion to be welded for welding the balance weight 4 is not formed between the lid portion 95 and the yoke portion 96 is used in the embodiment.

As shown in FIG. 4, the fitting portion 94 has a cylindrical shape. The plural sharp outer peripheral ridges 97 are formed in the circumferential direction on the outer peripheral surface of the fitting portion 94 as described above. The outer peripheral ridges 97 bite into the inner peripheral surface of the rear end portion 22, and the second propeller shaft 2 is engaged with the outer peripheral ridges 97 in the circumferential direction. Accordingly, when the second propeller shaft 2 rotates, the stub yoke 91 definitely rotates.

A not-shown adhesive is applied between the rear end portion 22 of the second propeller shaft 2 and the fitting portion 94 of the stub yoke 91.

As shown in FIG. 3, the lid portion 95 is formed to have a larger diameter than the fitting portion 94. Then, a peripheral end portion 95a of the lid portion 95 forms a flange portion abutting on the rear end surface 22b of the rear end portion 22.

In the second propeller shaft 2 and the cardan joint 9, a front end surface 95b of the peripheral end portion 95a and the rear end surface 22b of the rear end portion 22 correspond to “matching surfaces” described in claims.

### First Constant Velocity Joint

As shown in FIG. 1, the first constant velocity joint 8 is a double-offset type joint.

The first constant velocity joint 8 includes the first stub shaft 81 having an approximately columnar shape extending forward from the first propeller shaft 1, a driven member 82 provided at a tip of the first stub shaft 81 and a tubular outer-race 83 penetrating in the front and rear direction.

A flange 83a for connecting to a companion flange connected to an output shaft of the transmission is formed in a front end side of an outer peripheral surface of the outer-race 83.

The first stub shaft 81 includes the fitting portion (not shown) fitted to the front end portion 11 of the first propeller shaft 1, a lid portion (not shown) blocking the opening of the front end portion 11 of the first propeller shaft 1 and a shaft portion 85 extending forward from the lid portion (not shown). These components are integrally formed.

That is, the first stub shaft 81 in which a columnar portion to be welded for welding the balance weight 4 is not formed between the lid portion and the shaft portion 85 is used in the embodiment.

In an outer peripheral surface of the fitting portion of the first stub shaft 81, plural sharp outer peripheral ridges are formed in the circumferential direction in the same manner as the fitting portion 94 of the stub yoke 91 shown in FIG. 4. The outer peripheral ridges bite into the inner peripheral surface of the front end portion 11 of the first propeller shaft 1, and outer peripheral ridges are engaged with the first propeller shaft 1 in the circumferential direction.

In lid portions (not shown) of the first stub shaft 81 and the later-described second stub shaft 31 fitted to the first propeller shaft 1, the flange portion (peripheral end portion 95a) abutting on the rear end surface 22b of the second propeller shaft 2 as in the lid portion 95 of the stub yoke 91 is not provided (see FIG. 3). Accordingly, when a load due to a collision from the front direction is received, the first stub shaft 81 and the second stub shaft 31 easily enter the inside of the first propeller shaft 1, in other words, the shafts can be shortened easily.

### Second Constant Velocity Joint

The second constant velocity joint 3 is a cross-groove type joint.

The second constant velocity joint 3 includes the second stub shaft 31 having an approximately columnar shape extending backward from the rear end portion 12 of the first propeller shaft 1, an approximately cylindrical companion flange 32 attached to a rear end of the second stub shaft 31 and opening backward, an outer race 33 supported by the companion flange 32, the third stub shaft 34 having an approximately columnar shape extending forward from the front end portion 21 of the second propeller shaft 2 and a driven member 35 provided in the third stub shaft 34.

The second stub shaft 31 includes a fitting portion (not shown) fitted into the rear end portion 12 of the first propeller shaft 1, a lid portion (not shown) blocking the opening of the rear end portion 12 of the first propeller shaft 1 and a shaft portion 36 extending backward from the lid portion (not shown).

The third stub shaft 34 includes a fitting portion (not shown) fitted into the front end portion 21 of the second propeller shaft 2, a lid portion 37 blocking the opening of the front end portion 21 of the second propeller shaft 2 and a shaft portion 38 extending forward from the lid portion 37.

That is, the second stub shaft 31 and the third stub shaft 34 in which a columnar portion to be welded for welding the balance weight 4 is not formed between the lid portion 37 and the shaft portions 36, 38 are used in the embodiment.

The plural sharp outer peripheral ridges (refer to “the outer peripheral ridges 97” in FIG. 4) are formed in the circumferential direction on the outer peripheral surface of the fitting portion of the second stub shaft 31 and the outer peripheral surface of the fitting portion of the third stub shaft 34. The outer peripheral ridges of the second stub shaft 31 bite into the inner peripheral surface of the rear end portion 12 of the first propeller shaft 1, and the outer peripheral ridges are engaged with the first propeller shaft 1 in the circumferential direction.

Similarly, the outer peripheral ridges of the third stub shaft 34 bite into the inner peripheral surface of the front end potion 21 of the second propeller shaft 2, and the outer peripheral ridges are engaged with the second propeller shaft 2 in the circumferential direction.

Furthermore, an intermediate bearing unit 6 rotatably supporting the second stub shaft 31 with respect to the vehicle body is attached to the shaft portion 36 of the second stub shaft 31.

Next, the balance weights 4 and the covering members 5 will be explained.

### Balance Weight and Covering Member

As shown in FIG. 4, the balance weights 4 are metal weights arranged on the outer peripheral surfaces of the first propeller shaft 1 and the second propeller shaft 2 for matching the center of gravity of the propeller shaft 100 to the rotation centers.

The covering members 5 are members for covering the outer peripheral surfaces of the first propeller shaft 1 and the second propeller shaft 2 and the balance weights 4 to thereby fix the balance weights 4 to the first propeller shaft 1 and the second propeller shaft 2.

The balance weights 4 without coating (rust prevention treatment) are used as the balance weights 4 are covered with the covering members 5.

As shown in FIG. 1, the balance weights 4 includes a first balance weight 41, a second balance weight 42 and a third balance weight 43.

The first balance weight 41 is positioned in the front end portion 11 of the first propeller shaft 1, correcting the center of gravity in the front side of the propeller shaft 100.

The second balance weight 42 is positioned in the rear end portion 12 of the first propeller shaft 1, correcting the center of gravity in the central part of the propeller shaft 100.

The third balance weight 43 is positioned in the rear end portion 22 of the second propeller shaft 2, correcting the center of gravity in the rear side of the propeller shaft 100.

The first balance weight 41 to the third balance weight 43 may be adhered to respective outer peripheral surfaces by an adhesive.

As shown in FIG. 1, the covering members 5 include a first covering member 51, a second covering member 52 and a third covering member 53.

The first covering member 51 is positioned in the front end portion 11 of the first propeller shaft 1, fixing the first balance weight 41.

The second covering member 52 is positioned in the rear end portion 12 of the first propeller shaft 1, fixing the second balance weight 42.

The third covering member 53 is positioned in the rear end portion 22 of the second propeller shaft 2, fixing the third balance weight 43.

As shown in FIG. 3, the third covering member 53 extends from the rear end portion 22 to a rear end surface 95c of the lid portion 95 of the stub yoke 91.

Accordingly, the matching surfaces of the second propeller shaft 2 and the stub yoke 91 (the rear end surface 22b of the rear end portion 22 and the front end surface 95b of the peripheral end portion 95a) are covered with the third covering member 53. Therefore, the intrusion of water into the second propeller shaft 2 from the matching surfaces hardly occurs, which prevents rust in the fitting portion 94.

Similarly, as shown in FIG. 1, the first covering member 51 covers matching surfaces of the first propeller shaft 1 and the first stub shaft 81, and the second covering member 52 covers matching surfaces of the first propeller shaft 1 and the second stub shaft 31.

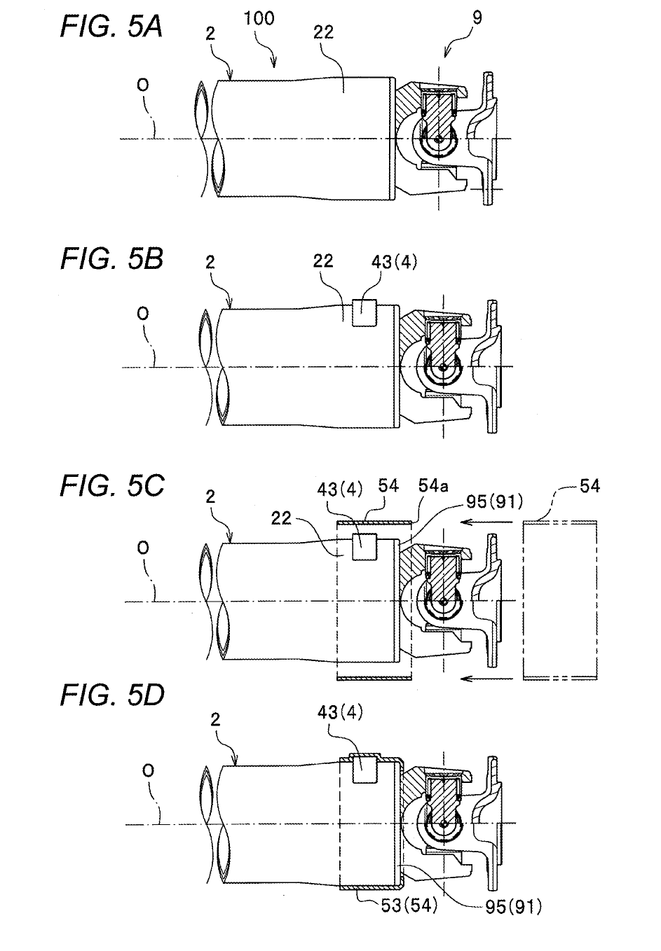

The covering members 5 are formed of a heat shrinkable tube 54 (see FIGS. 5) which shrinks by heating. As resins for forming the heat shrinkable tube 54, for example, fluororesins and polyolefin resins having high heat resistance can be cited, more specifically, polyvinylidene fluoride and so on can be used.

Next, a method of forming the covering members 5 will be explained with reference to FIGS. 5A to 5D.

As methods of forming the first covering members 51 to the third covering member 53 are the same, a method of forming the third covering member 53 will be explained as a representative example.

First, the center of gravity of the assembled propeller shaft 100 is measured by a balance measuring device, and a weight of the balance weight 4 and a phase in which the balance weight 4 is arranged are calculated.

As shown in FIG. 5B, the third balance weight 43 is arranged on an outer peripheral surface of the rear end portion 22 of the second propeller shaft 2. It is also possible to apply an adhesive to the third balance weight 43 to adhere the third balance weight 43 to the rear end portion 22 of the second propeller shaft 2.

Next, as shown in FIG. 5C, the heat shrinkable tube 54 is inserted from the rear direction of the propeller shaft 100 and the heat shrinkable tube 54 is arranged so as to overlap the rear end portion 22 of the second propeller shaft 2 in the front and rear direction.

A rear end portion 54a of the heat shrinkable tube 54 is arranged so as to be positioned behind the lid portion 95 of the stub yoke 91 so that the rear end portion 54a of the heat shrinkable tube 54 extends to the rear end surface 95c of the lid portion 95 when the heat shrinkable tube 54 shrinks by heating.

Next, as shown in FIG. 5D, the heat shrinkable tube 54 is heated. Accordingly, the heat shrinkable tube 54 shrinks to the inside in the radial direction, and the third covering member 53 covering the rear end portion 22, the third balance weight 43 and the lid portion 95 of the stub yoke 91 is formed.

There is no concern that the third balance weight 43 is displaced when the heat shrinkable tube 54 shrinks by adhering the third balance weight 43.

As described above, according to the embodiment, as the covering members 5 for fixing the balance weights 4 can be formed by heating the heat shrinkable tube 54, the work of fixing the balance weights 4 can be easily performed. Additionally, it is not necessary to induce the resin by a magnetic force or to wait for curing of the resin as explained in the related art. Moreover, it is not necessary to apply coating (rust prevention treatment) of the balance weights 4 and so on after fixing the balance weights as explained in the related art. Accordingly, the efficiency in the balance correction operation can be improved.

Also according to the embodiment, the balance weights 4 are fixed to the tubular bodies (the first propeller shaft 1 and the second propeller shaft 2), therefore, it is not necessary to provide the portions to be welded in the universal joint (the cardan joint 9, the first constant velocity joint 8 and the second constant velocity joint 3). Accordingly, the universal joint can be reduced in size and weight.

Also according to the embodiment, the matching surfaces 5 of the universal joint (the cardan joint 9, the first constant velocity joint 8 and the second constant velocity joint 3) and the tubular bodies (the first propeller shaft 1 and the second propeller shaft 2) are covered with the covering members 5, therefore, corrosion resistance is improved.

Also according to the embodiment, the heat shrinkable tube 54 is shortened, therefore, air intrusion between the heat shrinkable tube 54 (the covering members 5) and the tubular bodies (the first propeller shaft 1 and the second propeller shaft 2) hardly occurs when the heat shrinkable tube 54 shrinks by heating, and the adhesion between the tubular bodies (the first propeller shaft 1 and the second propeller shaft 2) and the coating members 5 is high. Therefore, the fixing force of the balance weights 4 is increased.

Additionally, when the balance weights 4 are adhered by an adhesive 24 in addition to the covering members 5, the fixing force of the balance weights 4 is increased.

The embodiment has been described above, however, the present invention is not limited to the examples explained in the embodiment.

For example, the tubular bodies made of CFRP are used for the first propeller shaft 1 and the second propeller shaft 2 in the embodiment, however, tubular bodies made of steel or aluminum may be used.

What is claimed is:

1. A vehicle propeller shaft comprising:
tubular bodies extending in a front and rear direction;
balance weights arranged on outer peripheral surfaces of the tubular bodies; and
covering members covering the outer peripheral surfaces of the tubular bodies and the balance weights,
wherein the covering members are formed of a heat shrinkable tube which shrinks by heating.

2. The vehicle propeller shaft according to claim 1,
wherein the covering members cover matching surfaces of universal joints connected to end portions of the tubular bodies and the end portions of the tubular bodies.

3. The vehicle propeller shaft according to claim 1,
wherein the balance weights are adhered to the tubular bodies by an adhesive.

4. The vehicle propeller shaft according to claim 2,
wherein the balance weights are adhered to the tubular bodies by an adhesive.

5. The vehicle propeller shaft according to claim 1,
wherein the tubular bodies are made of any one of carbon-fiber-reinforced plastic, steel and aluminum.

6. The vehicle propeller shaft according to claim 2,
wherein the tubular bodies are made of any one of carbon-fiber-reinforced plastic, steel and aluminum.

7. The vehicle propeller shaft according to claim 3,
wherein the tubular bodies are made of any one of carbon-fiber-reinforced plastic, steel and aluminum.

8. The vehicle propeller shaft according to claim 4,
wherein the tubular bodies are made of any one of carbon-fiber-reinforced plastic, steel and aluminum.
